(19) United States
(12) Patent Application Publication
(10) Pub. No.: US 2025/0038977 A1
(43) Pub. Date: Jan. 30, 2025

(54) MASKING WITH EFFICIENT UNMASKING VIA DOMAIN EMBEDDING IN CRYPTOGRAPHIC DEVICES AND APPLICATIONS

(71) Applicant: CRYPTOGRAPHY RESEARCH, INC., San Jose, CA (US)

(72) Inventors: Mark Evan Marson, Carlsbad, CA (US); Michael Alexander Hamburg, ‘s-Hertogenbosch (NL); Helena Handschuh, Miami, FL (US)

(21) Appl. No.: 18/784,550

(22) Filed: Jul. 25, 2024

Related U.S. Application Data
(60) Provisional application No. 63/529,243, filed on Jul. 27, 2023.

(51) Int. Cl. H04L 9/30; H04L 9/00

(52) U.S. Cl. CPC H04L 9/3093; H04L 9/002; H04L 9/008

(57) ABSTRACT

Disclosed aspects and implementations are directed to systems and techniques for protecting cryptographic operations against side-channel attacks. In one example, polynomials associated with secret data and public data defined on a working domain having a first dimension are mapped to an auxiliary domain having a larger second dimension. The mapped polynomials are masked using masking polynomials associated with a kernel of a homomorphism transformation from the auxiliary domain to the working domain. One or more computations are then performed on the masked polynomials in the auxiliary domain and an output is transformed from the auxiliary domain to the working domain.

### RELATED APPLICATIONS

This application claims the benefit of U.S. Provisional Patent Application No. 63/529,243, filed Jul. 27, 2023, entitled “MASKING WITH EFFICIENT UNMASKING VIA DOMAIN EMBEDDING IN CRYPTOGRAPHIC DEVICES AND APPLICATION,” the entire contents of which are incorporated by reference herein.

### TECHNICAL FIELD

Aspects of the present disclosure are directed to cryptographic computing applications, more specifically to protection of lattice-based post-quantum cryptographic applications from side-channel attacks.

### BRIEF DESCRIPTION OF THE DRAWINGS

The present disclosure will be understood more fully from the detailed description given below and from the accompanying drawings of various implementations of the disclosure.

FIGS. 1A-1B illustrate example computing architectures in which various implementations of the present disclosure may operate.

FIG. 2 is a block diagram illustrating an example computing system capable of protecting secret data against side-channel attacks using a domain embedding, in accordance with one or more aspects of the present disclosure.

FIG. 3 is an example data flow of a decryption process that protects secret data against side-channel attacks by domain embedding of polynomial computations, in accordance with one or more aspects of the present disclosure.

FIG. 4 depicts a flow diagram of an example method of protecting secret data against side-channel attacks by domain embedding of polynomial computations, in accordance with one or more aspects of the present disclosure.

FIG. 5 depicts a block diagram of an example computer system operating in accordance with one or more aspects of the present disclosure.

### DETAILED DESCRIPTION

In public-key cryptography systems, a processing device may have various components/modules used for cryptographic operations on input messages, which are typically represented via large integers. Cryptographic algorithms often involve modular arithmetic operations with modulus q, in which the set of all integers Z is wrapped around a circle of length q (the set Z_{q}), so that any two numbers that differ by q (or any other integer multiple of q) are congruent to (and treated as) the same number within Z_{q}. Pre-quantum cryptographic applications such as the Rivest-Shamir-Adelman (RSA) algorithm, digital signature algorithms (DSA), Diffie-Hellman key exchange (DH), Elliptic Curve Cryptography (ECC), and the like-exploit the fact that solving an integer factorization problem, a discrete logarithm problem, an elliptic curve discrete logarithm problem, and/or the like, involves prohibitively difficult operations (for large moduli q) on a classical computer.

Progress in quantum computing technology has placed conventional public key encryption schemes into jeopardy. In response, in 2016, the National Institute of Standards and Technology (NIST) initiated a Post-Quantum Cryptography (PQC) standardization process to promote development of public-key cryptographic algorithms that are resistant against attacks using quantum computers. In July 2022, after rigorous analysis and evaluation, NIST has finalized the following algorithms: CRYSTALS-KYBER (referred to as Kyber herein) key encapsulation mechanism (KEM), CRYSTALS-DILITHIUM digital signatures algorithm (referred to as Dilithium herein), FALCON digital signatures algorithm, and SPHINCS+ hash-based signature algorithm. In particular, NIST recommended Dilithium as the primary signature algorithm. Additional KEM algorithms are currently considered, including BIKE, Classic McEliece, and HQC. Further NIST competitions have been initiated for signature algorithms that are based on different mathematical foundations.

As an example, Kyber algorithm—is based on the Module-Learning-With-Errors (MLWE) problem on structured lattices with the underlying operations involving matrix-vector (and vector-vector) multiplications where the elements of the matrices/vectors are polynomials defined on a ring R_{q}=Z_{q}[x]/(xⁿ+1), namely polynomials with coefficients in Z_{q} and polynomial operations defined modulo the modulus polynomial xⁿ+1. Although confidential data encrypted using Kyber and/or other similar polynomial-based cryptographic techniques may be well protected from unauthorized accesses while in the ciphertext form, a weak security link occurs on a sender's or a recipient's side, where a private key may be exposed. In particular, decryption typically includes computing polynomial products of a series of ciphertexts c₁(x), c₂(x), c₃(x), . . . and some secret polynomials s(x) (e.g., the private key or other secret data derived from the private key). As the same secret data is multiplied over and over by varying and known (to the attacker) ciphertexts, the secret data may become vulnerable to side-channel attacks. During a side-channel attack, an attacker observes a large number of multiplications s(x)·c₁(x), s(x)·c₂(x), s(x)·c₃(x) . . . and monitors signals produced by electronic circuits of the targeted computer. Monitored signals may be acoustic, electrical, magnetic, optical, thermal, and so on. By recording such signals, a hardware trojan and/or a malicious software may correlate specific processor (and/or memory) activity with computations carried out by the targeted computer. A simple power analysis (SPA) side-channel attack involves examination of the electrical power used by the device as a function of time. As presence of noise hides the signal of the processor/memory, a more sophisticated differential power analysis (DPA) attack may include statistical analysis of power measurements performed over multiple cryptographic operations (or multiple iterations of a single cryptographic operation). An attacker employing DPA may filter out the noise component of the power signal (using the fact that the noise components may be uncorrelated between different operations or iterations) to extract the component of the signal that is representative of the actual processor activity, and to infer the value of the secret polynomial s(x) from this signal, thus gaining access to the private key.

Although the above illustration uses the Kyber algorithm as an example, similar side channel attacks can be used to compromise integrity of digital signature algorithms, including the Dilithium algorithm, FALCON algorithm, and/or other digital signature algorithms.

Protection against side-channel attacks includes various masking techniques. Masking involves generating a random (or pseudorandom) masking polynomial m(x) and combining (e.g., adding, multiplying, etc.) the secret polynomial s(x) with the masking polynomial to reduce correlations of side-channel measurements with the secret polynomial. Masking, however, comes at the cost of additional computations, since it is typically necessary to perform computations on both the masked data, e.g., s(x)+m(x), and the masking data m(x) separately before using the results of these two (or more) computations to unmask a final output. This increases latency, reduces computational throughput, and consumes valuable processing and memory resources.

Aspects and implementations of the present disclosure address these and other challenges of the existing technology by enabling systems and techniques to implement masking that does not require performing separate computations on both the masked data and the masking data and enables efficient unmasking (combining) operations at the end of the algorithm. More specifically, products of a large secret polynomial and a large public polynomial are known to be efficiently computed using Number Theoretic Transforms (NTTs, described in more detail below) that are analogous to Digital Fourier Transforms and can be performed using only O(n log n) operations (rather than O(n²) operations for a conventional schoolbook multiplication). For example, a set {sᵢ} of coefficients of a polynomial s(x)=Σᵢ₌₀ⁿ⁻¹ sᵢxⁱ may be transformed to the NTT domain, {sᵢ}→{ŝᵢ} (and similarly for other polynomials, e.g., {cᵢ}→{ĉᵢ}), where a product of two polynomials, p(x)=s(x)·c(x), is represented by a set of coefficients {\hat{p}ᵢ}={ŝᵢĉᵢ} that are elementwise products of the coefficients of the two sets. An inverse NTT then transforms the obtained set, {\hat{p}ᵢ}→{pᵢ}, to the set of the product polynomial p(x)=Σᵢ₌₀ⁿ⁻¹pᵢxⁱ (e.g., an output of the cryptographic operation). The NTT/inverse NTT operations as well as NTT domain products may be modulo-q operations, where q is set by a particular algorithm specification, e.g., q=13×2⁸+1=3329 for Kyber, q=2²³−2¹³+1=8380417 for dilithium, and the like.

In some implementations of the present disclosure, to mask various polynomial operations, a larger circle Z_{Q} (auxiliary domain) may be selected for masking operations that embeds Z_{Q}, such that q divides Q with Q/q being an integer much greater than one, e.g., 2⁸, 2¹², 2¹⁶, or some other number. The polynomials can be mapped from sᵢ, cᵢ∈Z_{q} to Sᵢ, Cᵢ∈Z_{Q}, which may be accompanied by adding arbitrary masking polynomials M_{S}(x), M_{C}(x) multiplied by modulus q: S(x)=s(x)+qM_{S}(x), C(x)=c(x)+qM_{C}(x). Such addition, while efficiently masking the polynomials in the Z_{Q} domain, nonetheless retains information about the original polynomials s(x) and c(x). Correspondingly, when the final product P(x) computed in Z_{Q} is transformed back to the working domain Z_{q}, P(x)→p(x), the result p(x) automatically amounts to the correct product s(x)·c(x) without any need for additional unmasking or separate computations performed on the masks.

This and various other disclosed techniques are not limited to lattice-based algorithms and may be used in a variety of cryptographic devices and applications. Numerous additional implementations are disclosed herein. The advantages of the disclosed implementations include, but are not limited to, secure execution of cryptographic applications using masking techniques that do not require separate unmasking operations and/or separate parallel computations on the masking polynomials. The disclosed implementations may be used in public key cryptography, symmetric key cryptography, digital signature algorithms, homomorphic encryption, and/or various other cryptographic applications.

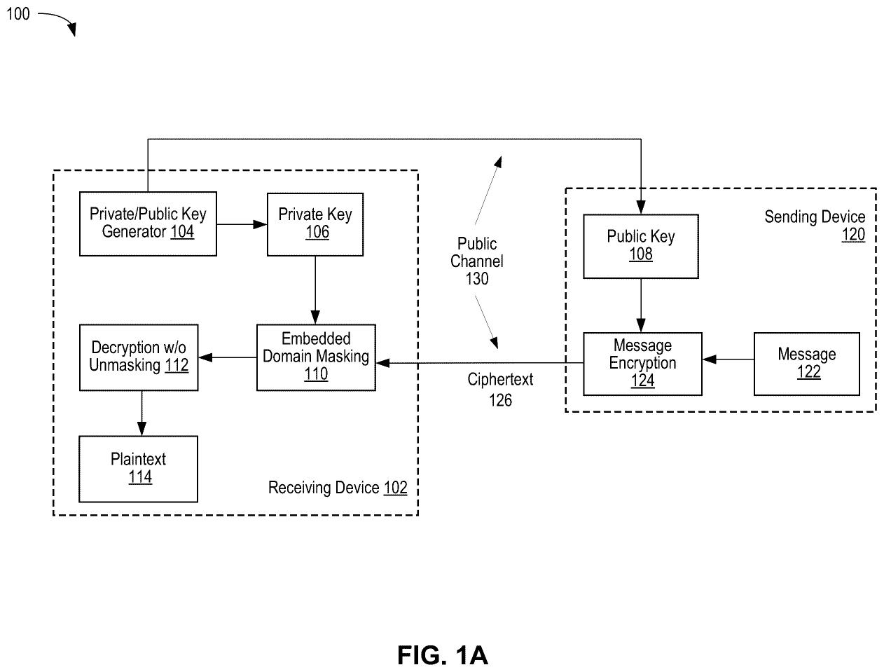

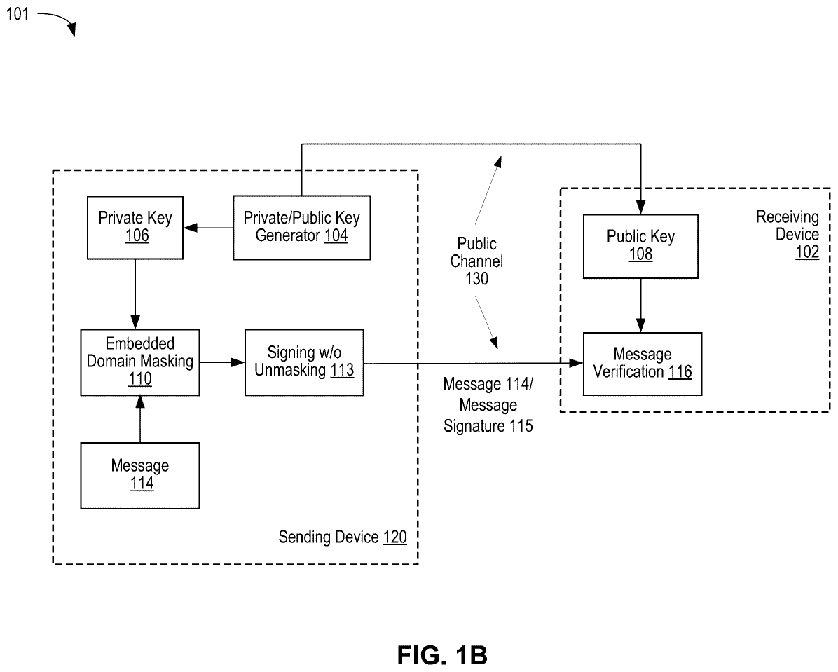

FIG. 1A illustrates an example computing architecture 100 in which various implementations of the present disclosure may operate. For illustration, computing architecture 100 implements public/private key cryptography, but a similar architecture may be used in symmetric key cryptographic applications. Computing architecture 100 may include various components/modules/applications that are not explicitly depicted in FIG. 1A, including but not limited to various domain-specific applications that perform operations on output or input messages. Computing architecture 100 may include a receiving device 102 deploying a cryptographic application-specific private/public key generator 104 that may generate a private key 106 and a public key 108. Receiving device 102 may provide public key 108 to a sending device 120, which uses public key 108 to encrypt a message 122 before sending ciphertext (encrypted message) 126 over a public communication channel 130, which may include any network, e.g., Internet, local area network, wide area network, and/or the like. Message 122 may be encrypted by a message encryption module 124 implementing any suitable encryption scheme. In some implementations, the encryption scheme may be one of the post-quantum encryption schemes, including but not limited to Kywber, and/or other similar algorithms.

As disclosed herein, an embedded domain masking 110 may receive ciphertexts 126 and private key 106 may implement masking to protect the private key 106 (or any other secret data derived from private key 106) from a side-channel attack during decryption of the received ciphertext 126. Although, for illustration, ciphertext(s) and plaintext(s) are generated/processed by different devices in the illustration of FIG. 1A, in some instances ciphertext(s) and plaintext(s) may be generated/processed by the same device. For example, sending device 120 may be the same device as receiving device 102.

Embedded domain masking 110 may select an auxiliary domain Z_{Q} that embeds the working domain Z_{q}, e.g., by using a random process (or a constrained random process), as disclosed below. Embedded domain masking 110 may further select masking polynomials for the secret and public data. Decryption without unmasking module 112 may perform the decryption process, e.g., by first transforming the two polynomials to the NTT domain in Z_{Q}, multiplying polynomial coefficients, performing the inverse NTT, and then transforming the product embedded into Z_{Q} into the working domain Z_{q} in such a way that a correct plaintext 114 is obtained without any special unmasking or separate computations handling the masks.

FIG. 1B illustrates another example computing architecture 101 in which various implementations of the present disclosure may operate. Computing architecture 101 implements document authentication using digital signature algorithms. As illustrated in FIG. 1B, sending device 120 may deploy private/public key generator 104 that generates a private key 106 and a public key 108. Sending device 120 may provide public key 108 to receiving device 102. Sending device may authenticate message 114 using private key 106. In some implementations, embedded domain masking 110 may receive message 114 (or some representation of the message, e.g., a message hash) and use private key 106 (or some other secret data derived from private key 106) to obtain a message signature 115. Embedded domain masking 110 may implement masking to protect private key 106 (or other secret data) from a side-channel attack during encryption of hash 115, e.g., using polynomial masking techniques disclosed in more detail below. Signing without unmasking module 113 may protect private key 106 by transforming involved polynomials to an NTT domain, performing polynomial multiplication in the NTT domain, computing inverse NTT(s), and/or the like.

Sending device 120 may then send message signature 115 together with message 114 to receiving device 102 over public communication channel 130. Receiving device 102 may use public key 108 to perform message verification 116 of message signature, e.g., using public key 106 (and, optionally, the message hash). In some implementations, the digital signature scheme may be one of the post-quantum digital signature schemes, including but not limited to Dilithium FALCON, and/or the like.

Although, in the illustration of FIG. 1B different devices perform a signature algorithm and verification, in some instances both algorithms may be performed by the same device (e.g., with sending device 120 being the same as receiving device 102).

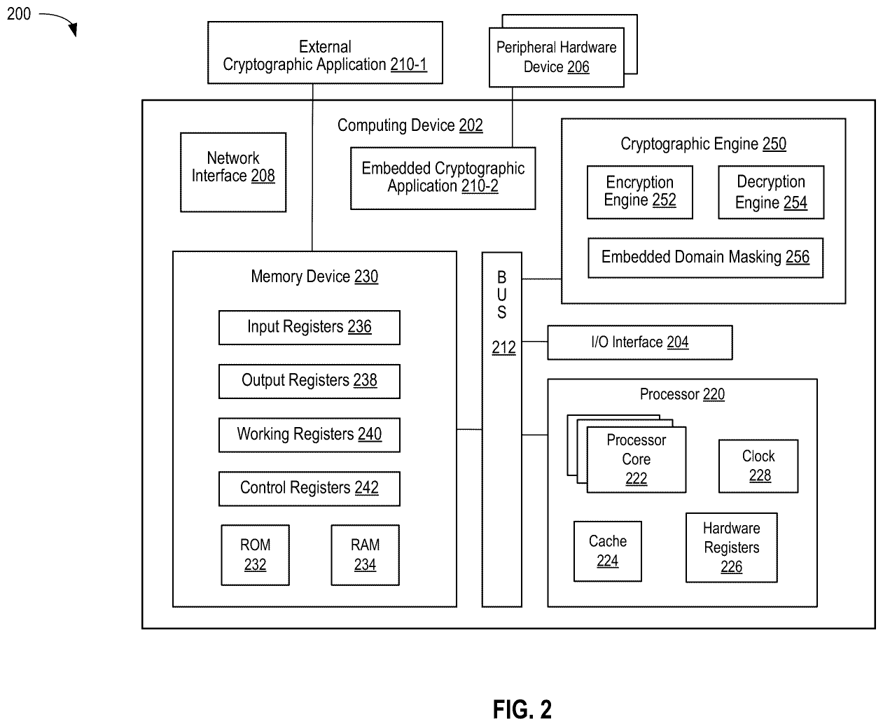

FIG. 2 is a block diagram illustrating an example computing system 200 capable of protecting secret data against side-channel attacks using a domain embedding, in accordance with one or more aspects of the present disclosure. Example computing system 200 may be a desktop computer, a tablet, a smartphone, a server (local or remote), a thin/lean client, and the like. Example computing system 200 may be a smart card reader, a wireless sensor node, an embedded system dedicated to one or more specific applications (e.g., cryptographic applications 210-n), and so on. Example computing system 200 may include (but need not be limited to) a computing device 202 having one or more processors 220 (e.g., central processing units (CPUs)) capable of executing binary instructions, and one or more memory devices 230. Herein “processor” or “processing device” refers to a device capable of executing instructions encoding arithmetic, logical, or I/O operations. In one illustrative example, a processing device may follow von Neumann architectural model and may include an arithmetic logic unit (ALU), a control unit, and a plurality of registers. A processing device may be a single-core processor capable of executing one instruction at a time (or process a single pipeline of instructions), or a multi-core processor capable of simultaneous execution of multiple instructions. A processing device may be implemented as a single integrated circuit, two or more integrated circuits, or may be a component of a multi-chip module. A processing device may be or include a CPU, a graphics processing unit (GPU), a field-programmable gate array (FPGA), an application-specific integrated circuit (ASIC), or any combination thereof.

Example computing system 200 may include an input/output (I/O) interface 204 to facilitate connection of computing device 202 with peripheral hardware devices 206 such as card readers, terminals, printers, scanners, internet-of-things devices, and the like. Example computing system 200 may further include a network interface 208 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computing device 202. For example, network interface 208 may be used to support a connection to sending device 120 of FIGS. 1A-1B. Various hardware components of computing device 202 may be connected via a bus 212, which may have its own logic circuits.

Example computing system 200 may support one or more cryptographic applications 210-n, such as one or more external cryptographic applications 210-1 and/or one or more embedded cryptographic applications 210-2. Cryptographic applications 210-n may be secure authentication applications, public key signature applications, key encapsulation applications, key decapsulation applications, encryption applications, decryption applications, fully homomorphic encryption/decryption applications, secure storage applications, and so on. External cryptographic application 210-1 may be instantiated on the same computing device 202, e.g., by an operating system executed by the processor 220 and residing in a memory device 230. Alternatively, external cryptographic application 210-1 may be instantiated by a guest operating system supported by a virtual machine monitor (hypervisor) executed by the processor 220. In some implementations, external cryptographic application 210-1 may reside on a remote access client device or a remote server (not shown), with the computer device 202 providing cryptographic support for the client device and/or the remote server.

Processor 220 may include one or more processor cores 222 having access to cache 224 (e.g., a single-level or multi-level cache) and one or more hardware registers 226. In some implementations, each processor core 222 may execute instructions to run a number of hardware threads, also known as logical processors. Various logical processors (or processor cores) may be assigned to one or more cryptographic applications 210-n, although more than one processor may be assigned to a single cryptographic application for parallel processing. Memory device 230 may refer to a volatile or non-volatile memory and may include a read-only memory (ROM) 232, a random-access memory (RAM) 234, as well as (not shown) electrically erasable programmable read-only memory (EEPROM), flash memory, flip-flop memory, or any other device capable of storing data. RAM 234 may be a dynamic random access memory (DRAM), synchronous DRAM (SDRAM), a static memory, such as static random access memory (SRAM), and the like.

Memory device 230 may include one or more registers, such as one or more input registers 236 to store cryptographic keys, input polynomials, and other data for cryptographic applications 210-n. Memory device 230 may further include one or more output registers 238 to store outputs of cryptographic application, and one or more working registers 240 to store various intermediate values generated in the course of performing cryptographic computations, including masking operations. Memory device 230 may also include one or more control registers 242 for storing information about modes of operation, selecting a cryptographic algorithm, initializing cryptographic computations, selecting a masking mode, selecting auxiliary domain Z_{Q}, sampling masking polynomials, modifying secret and ciphertext data with sampled polynomials, and/or the like. Control registers 242 may communicate with one or more processor cores 222 and a clock 228, which may keep track of a processing operation (e.g., iteration of the NTT/inverse NTT) being performed. In some implementations, registers 236-242 may be implemented as part of RAM 234. In some implementations, some or all of the registers 236-242 may be implemented separately from RAM 234. Some of or all registers 236-242 may be implemented as part of processor 220 (e.g., as part of the hardware registers 226). In some implementations, processor 220 and memory device 230 may be implemented as a single field-programmable gate array (FPGA).

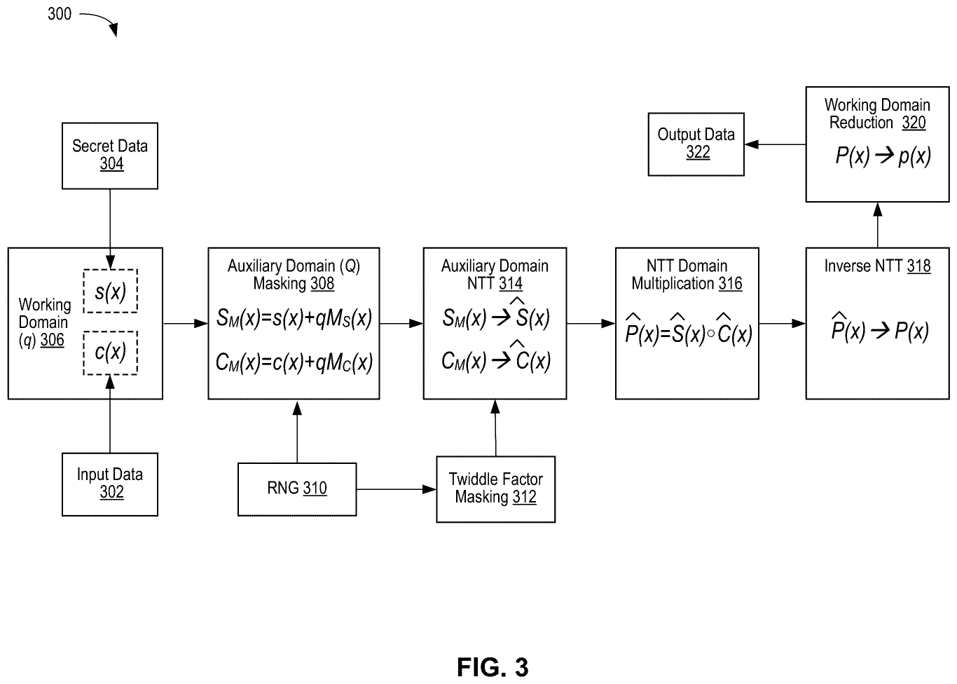

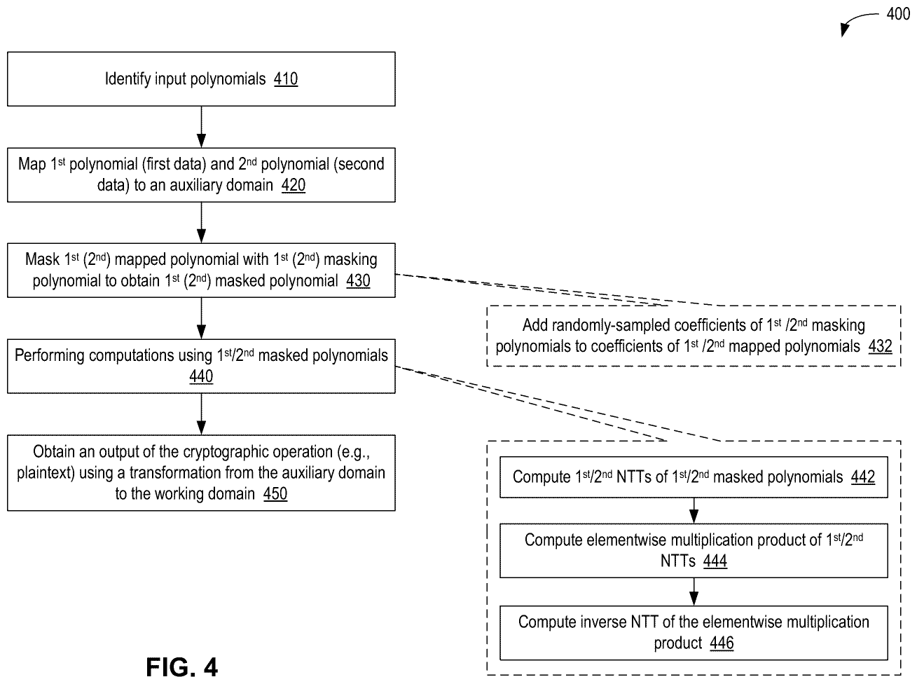

Computing device 202 may include a cryptographic engine 250 to support cryptographic operations of processor 220. Cryptographic engine 250 may be configured to perform side-channel attack-resistant cryptographic operations, in accordance with implementations of the present disclosure. As depicted in FIG. 2, cryptographic engine 250 may be a separate hardware component, e.g., an accelerator. In some implementations, cryptographic engine 250 may be implemented as a software (or firmware) module instantiated in memory device 230. In some implementations, cryptographic engine 250 may be partially implemented as a hardware component and partially as a software (or firmware) module. Cryptographic engine 250 may include an encryption engine 252 to encrypt plaintext messages and generate ciphertexts. Cryptographic engine 250 may also include a decryption engine 254 to decrypt ciphertexts and recover plaintext messages. Decryption engine 254 (and, in some implementations, encryption engine 252) may use embedded domain masking 256 to mask secret data using operations that do not require additional unmasking computations to implement one or more techniques of the present disclosure, e.g., as described in more detail in conjunction with FIG. 3 and FIG. 4 below.

FIG. 3 is an example data flow of a cryptographic process 300 that protects secret data against side-channel attacks by domain embedding of polynomial computations, in accordance with one or more aspects of the present disclosure. In some implementations, cryptographic process 300 may be performed by various components and/or modules of receiving device 102 of FIGS. 1A-1B, e.g., cryptographic engine 250 of FIG. 2. In some implementations, cryptographic process 300 may be performed in the course of decryption of a input data 302 (e.g., ciphertext), which may be a confidential message encrypted using any suitable cryptosystem. In some implementations, the ciphertext may have been obtained (e.g., on the sending side) from a plaintext message by computing a multiplication product of a numerical representation (e.g., vector, matrix, etc.) of the plaintext message and a publicly available generating matrix, corrupting the computed product by adding (a vector or matrix of) randomly generated errors, and/or performing any other operations according to a particular encryption protocol being deployed. In some implementations, cryptographic process 300 may be performed in the course of an encryption of input data 302 (e.g., document hash).

While the underlying plaintext message may be confidential, the input data 302 itself may be public. Furthermore, during a side-channel attack, an attacker may generate many instances of input data 302 and observe processor and/or memory activity during decryption of the generated ciphertexts. (Alternatively, an attacker may observe processor/memory activity during processing of ciphertexts 302 generated by other entities.) Decryption or encryption of input data 302 may involve using a secret data 304, which may be any cryptographic key permanently stored on receiving device 102, ephemeral key or session key generated for a particular cryptographic episode, key generated to decrypt a particular message or a portion of a message, and/or any data string generated using secret key or other confidential information.

In one example implementation, input data 302 includes a set of numbers {cᵢ}=c₀ . . . cₙ₋₁, which may be represented as the polynomial c(x)=Σᵢ₌₀ⁿ⁻¹ cᵢxⁱ and transformed, in various arithmetic operations, as corresponding polynomial coefficients are transformed (for example, coefficients of a sum of two polynomials are given by sums-modulo a suitable modulus—of corresponding same-degree coefficients of the two polynomials). Similarly, secret data 304 may include a set of numbers {sᵢ}=s₀ . . . sₙ₋₁, which may be represented as the polynomial s(x)=Σᵢ₌₀ⁿ⁻¹ sᵢxⁱ. The polynomials c(x), s(x) are defined modulo a suitable modulus polynomial, which for the purpose of illustration and not limitation may be xⁿ+1. This choice of the modulus polynomial amounts to replacing powers x^{α} with a≥n that arise in various polynomial products as simply x^{α}→x^{α-n}. Correspondingly, the product p(x)=s(x)·c(x) has a set of coefficients {pᵢ} that are determined according to, pᵢ=Σⱼ₌₀ⁿ⁻¹ sᵢ₋ⱼcⱼ (mod q), namely a discrete convolution of sets {sᵢ} and {cᵢ}, in which coefficients sₖ with negative k are to be understood in the sense, s_{k<0}→sₖ₊ₙ The modulus q may be any suitable number, e.g., q=13×2⁸+1=3329 for Kyber and q=2²³−2¹³+1=8380417 for Dilithium. Direct computation of the coefficients {pᵢ} using the convolution formula involves O(n²) multiplication products sᵢ₋ⱼcⱼ. This number is reduced significantly (for n»1) by first transforming the polynomials into an NTT domain. More specifically, the n-point NTT transforms the polynomial s(x) (and, similarly, c(x)) into a polynomial ŝ(x) (and, similarly, Ĉ(x)) with the following coefficients,

$${\hat{s}}_{i} = {\sum }_{k = 0}^{n - 1} {s}_{k} {W}_{n}^{ik} mod q ,$$

where Wₙ is an nth principal root of unity modulo q. The inverse NTT determines polynomial {sᵢ} in terms of {ŝᵢ},

$${s}_{k} = \frac{1}{n} {\sum }_{i = 0}^{n - 1} {\hat{s}}_{i} {W}_{n}^{- ik} mod q .$$

As follows from the inverse NTT applied to the convolution formula, multiplication of the polynomials, s(x) and c(x) (or any other polynomials) is most simple in the NTT domain, as the coefficients of the NTTs of the product is the elementwise (Hadamard) product of the NTTs of the polynomials: \hat{p}ᵢ=ŝᵢĉᵢ, or symbolically \hat{p}(x)=ŝ(x)ĉ(x). Accordingly, a fast NTT-based multiplication of polynomials may be performed by (1) transforming the polynomials to the NTT domain, s(x)→ŝ(x), c(x)→ĉ(x), (2) computing the elementwise product, \hat{p}(x)=ŝ(x)ĉ(x), and (3) performing the inverse NTT transform, \hat{p}(x)→p(x).

Fast NTT (performed similarly to the Fast Fourier Transform) computes n/2 2-point butterfly transforms in each of log₂ n iterations. Essentially, a fast NTT amounts to computing n/2 2-point transforms in the first iteration followed by computing n/4 4-point transforms in the second iteration, and so on, until the last iteration produces the ultimate n-point NTT. Different groupings of input elements into each iteration may be used. Grouping even elements with adjacent odd elements gives rise to Cooley-Tukey butterfly operations, where two input elements into a particular iteration, A and B, are transformed into the output elements according to: A, B→A′=A+B·Wₙⁱ, B′=A−B·Wₙⁱ. Grouping elements from a first half of elements with corresponding elements from a second half gives rise to Gentleman-Sande butterfly operations, where input elements are transformed into the output elements according to: A, B→A′=A+B, B′=(A−B)·Wₙⁱ. Often, the Cooley-Tukey butterfly operations are used for the forward NTTs and the Gentleman-Sande butterfly operations are used for the inverse NTTs. In some algorithms (e.g., Kyber), two or more n/m-point NTTs may be computed, as described in more detail below.

To protect secret polynomials from exposure to side-channel attacks during the operations of the NTT transform and the NTT domain multiplications, polynomials s(x) and c(x) in working domain 306, in which the polynomial coefficients are defined in the domain (ring) Z_{q}, may be mapped to an auxiliary domain Z_{Q}. In the auxiliary domain, coefficients of polynomials s(x) and c(x) are defined modulo Q that is a multiple of the size of the working domain Q=mq, where m is an integer number, referred to as the domain scaling factor herein. In some implementations, the domain scaling factor may be a number that is much greater than one, e.g., 2⁶ or more. Initially the (unmasked) polynomials s(x) and c(x) may have the same coefficients in the auxiliary domain Z_{Q} as in the working domain Z_{q} while further computations (e.g., masking operations, additions, multiplications, etc.) with the polynomials may occur in the auxiliary domain that embeds the working domain. Multiplication of polynomials may be performed on an auxiliary ring R_{Q} [x]=Z_{Q} [x]/(xⁿ+1), using the same modulus polynomial xⁿ+1 as in the working domain Z_{q} but with the coefficients now defined in the auxiliary domain Z_{Q}. In some implementations, mapping of polynomial coefficients from the working domain to the auxiliary domain may be performed explicitly, e.g., by copying the coefficients from log₂ q-bit registers (or memory addresses) to log₂ Q-bit registers (or memory addresses) in which the log₂(Q/q) most significant bits are assigned zero values. In some implementations, mapping of polynomial coefficients may be performed implicitly, e.g., associating the coefficients with modulo-Q operations.

The expansion of the domain in which coefficients of various polynomials are defined, Z_{q}→Z_{Q} facilitates efficient masking of the polynomials. More specifically, auxiliary domain masking 308 may mask polynomials s(x) and c(x),

$${s ( x ) {\vert}_{∈ {R}_{q}} \to {S}_{M} ( x ) \vert}_{∈ {R}_{Q}} = s ( x ) + {qM}_{S} ( x ) ,$$

$${c ( x ) {\vert}_{∈ {R}_{q}} \to {C}_{M} ( x ) \vert}_{∈ {R}_{Q}} = c ( x ) + {qM}_{C} ( x ) ,$$

by adding arbitrary masking polynomials M_{S}(x) and M_{C}(x) (defined on R_{Q}) multiplied by the working domain modulus q. In some implementations, masking polynomials M_{S}(x) and M_{C}(x) may be polynomials of the same degree n−1 (as polynomials s(x) and c(x)) and coefficients that are randomly sampled from the auxiliary domain Z_{Q}, e.g., using any suitable random (or pseudorandom) number generator 310. In some implementations, different coefficients of the same masking polynomial may be sampled independently from each other.

Auxiliary domain NTT 314 computations may then be performed in the auxiliary domain, on the masked polynomials S_{M}(x) and C_{M}(x), e.g., substantially as described above. An output of auxiliary domain NTT 314 may include the NTT polynomials Ŝ(x), Ĉ(x) with coefficients in Z_{Q}. NTT multiplication 316 may then be performed using elementwise multiplication of the polynomial coefficients, \hat{P}i=ŜᵢĈᵢ. The obtained polynomial coefficients \hat{P}ᵢ may define a polynomial \hat{P}(x) associated with plaintext data. Inverse NTT 318 may transform the NTT polynomial \hat{P}(x) back from the NTT domain: \hat{P}(x)→P(x).

Since operations of blocks 314, 316, and 318 are performed starting from the masked polynomials S_{M}(x) and C_{M}(x) defined on the auxiliary polynomial ring R_{Q}=Z_{Q} [x]/(xⁿ+1) with coefficients in the auxiliary domain Z_{Q}, no secret data is revealed in the course of computations involved in operations of blocks 310 314, 316, and 318. The output P(x) may now be transformed from the auxiliary ring R_{Q} to R_{q}, by performing a reduction to the working domain, e.g.,

pᵢ=Pᵢ mod q,

resulting in a output data 322 (e.g., plaintext in decryption operations, signature in digital signature applications, and/or the like) represented by the polynomial p(x)=Σᵢ₌₀ⁿ⁻¹ pᵢxⁱ defined modulo the working domain modulus q.

In some implementations, additional masking may be performed, e.g., twiddle factor masking 312. For example, for the Cooley-Tukey butterfly operation (where A and B may be any pair of coefficients of the masked polynomials S_{M}(x) and C_{M}(x) or any pair of coefficients derived from S_{M}(x) and C_{M}(x) via one or more NTT/NTT domain/inverse NTT operations),

$${A}^{′} = A + B \cdot {W}_{n}^{i} ( mod Q ) ,$$

$${B}^{′} = A - B \cdot {W}_{n}^{i} ( mod Q ) ,$$

masking may be performed for one or both inputs A, B, and a twiddle factor Wₙⁱ. The masking may be performed modulo the auxiliary modulus Q. This does not affect the outputs in the working domain (modulo q). For example, masking A→A+M_{A}, B→B+M_{B}, and Wₙⁱ→ₙⁱ+M_{W} results in the following output (presenting only A′, for conciseness),

$${A}^{′} ( mod Q ) = A + B \cdot {W}_{n}^{i} + ( {M}_{A} + {M}_{B} {W}_{n}^{i} + {BM}_{W} + {M}_{B} {M}_{W} - aQ ) ,$$

where a is some integer that is used to bring A′ inside the domain Z_{Q}. It follows that all the terms in the parenthesis would disappear upon a mod q reduction of the right-hand side of the last identity, since each of the terms in the parenthesis is divisible by q (as all masks M_{α} and Q are so divisible, by construction). Similarly, any number of intervening operations, e.g., additions, subtractions, multiplications, divisions, exponentiations, and/or the like, do not affect the final output of decryption process 300, e.g., output data 322. Accordingly, no additional unmasking is required when the disclosed techniques are deployed, as working domain reduction 320 automatically recovers the correct plaintext values. Stated equivalently, to achieve masking without unmasking, the masking polynomials M_{S}(x) and M_{C}(x) may be selected from the kernel of homomorphism R_{Q}[x]→R_{q}[x], namely as the set of polynomials in R_{Q} [x] that map to a zero element of R_{q}[x].

Numerous implementations of secret data protection by domain embedding are within the scope of the present disclosure. It should be understood that although, in some implementations, input data 302 may be ciphertext 126 (see FIGS. 1A-1B) received (or retrieved) by receiving device 102 as an initial input into a cryptographic operation, in other implementations, input data 302 may be derived from (or using) ciphertext 126 over any number of intermediate computations. Similarly, while, in some implementations, output data 322 may be plaintext 114 (see FIG. 1), in other implementations, output data 322 may still undergo any number of intermediate computations before the final output plaintext is generated.

In some applications, a full n-point NTT may not exist. For example, Kyber uses the modulus polynomial x²⁵⁶+1, that does not factorize into a product of n=256 linear polynomials terms but factorizes into n/2=128 quadratic polynomials. In such instances, roots Wₙ¹, Wₙ³, Wₙ⁵, . . . Wₙⁿ⁻¹ may be used to implement two n/2-point NTTs, separately for even-numbered and odd-numbered coefficients of s(x) (and, similarly, c(x) and/or any other polynomial). For example (where mod q operations are implied but not explicitly stated, for brevity),

$${\hat{s}}_{i}^{even} = {\sum }_{k = 0}^{n / 2 - 1} {s}_{2 k} {W}_{n}^{i ( 2 k + 1 )} , {s}_{2 k} = \frac{2}{n} {\sum }_{i = 0}^{n / 2 - 1} {\hat{s}}_{i}^{even} {W}_{n}^{- i ( 2 k + 1 )} ,$$

$${\hat{s}}_{i}^{odd} = {\sum }_{k = 0}^{n / 2 - 1} {s}_{2 k + 1} {W}_{n}^{i ( 2 k + 1 )} , {s}_{2 k + 1} = \frac{2}{n} {\sum }_{i = 0}^{n / 2 - 1} {\hat{s}}_{i}^{odd} {W}_{n}^{- i ( 2 k + 1 )} .$$

Correspondingly, the convolution formula for the product of two polynomials results in the elementwise-pairwise multiplication of the respective even-numbered NTT and odd-numbered NTT,

$${\hat{p}}_{i}^{even} = {\hat{s}}_{i}^{even} \cdot {\hat{c}}_{i}^{even} + {W}_{n}^{2 i} \cdot {\hat{s}}_{i}^{odd} \cdot {\hat{c}}_{i}^{odd} ,$$

$${\hat{p}}_{i}^{odd} = {\hat{s}}_{i}^{even} \cdot {\hat{c}}_{i}^{odd} + {\hat{s}}_{i}^{odd} \cdot {\hat{c}}_{i}^{even} ,$$

or, equivalently, as the product of degree-one polynomials,

$${\hat{p}}_{i}^{even} + {\hat{p}}_{i}^{odd} x = ( {\hat{s}}_{i}^{even} + {\hat{s}}_{i}^{odd} x ) \cdot ( {\hat{c}}_{i}^{even} + {\hat{c}}_{i}^{odd} x ) mod ( {x}^{2} + {W}_{n}^{2 i} ) .$$

Similarly, when the highest-degree root has a degree n/m, where m=3, 4, etc., m sets of partial NTTs may be defined with the product of two polynomials defined in the NTT domain as products of degree m−1 polynomials. In each instance, secret data may be protected by masking various coefficients of those polynomials and/or twiddle factors W_{n/m}^{ik} by adding arbitrary masking coefficients q·M defined in the auxiliary domain Z_{Q}.

In some implementations, masking may be performed on initial polynomials s(x) and c(x) and/or twiddle factors W. In some implementations, re-masking of coefficients and/or twiddle factors may be performed (in the auxiliary domain Z_{Q}) after completion of some portion of the computations, e.g., after completion of any number of NTT and/or inverse NTT iterations, before and/or after NTT domain multiplications, and/or any combination thereof. Various polynomial coefficients as well as different twiddle factors may be masked independently from each other, e.g., some or all in the set of twiddle factors Wₙ⁰, Wₙ¹, . . . Wₙⁿ⁻¹ may be masked with masks that are different from masks used for other twiddle factors.

In some implementations, twiddle factors Wₙⁱ for performing the NTT on the auxiliary ring R_{Q} [x], may be the same as the original twiddle factors defined in the working domain Z_{q} and redefined in the auxiliary domain Z_{Q}. For example, each original twiddle factors may be stored using minimum ┌log q┐ bits. The twiddle factors in the auxiliary domain may use ┌log Q┐ bits, with the additional ┌log Q┐−┌log q┐ bits having zero values.

In some implementations, the twiddle factors for the NTT on R_{Q} [x] may be based on the principal root of unity \tilde{W}ₙ¹ that is different from Wₙ¹. In one example, the Hensel lifting algorithm may be used to obtain, (based on the principal root Wₙ¹ that obeys the equation (Wₙ¹)ⁿ=1 (mod q)), a root γ that obeys the equation, γⁿ=1 (mod q²). The obtained root may then be used, γ→\tilde{W}ₙ¹, as the principal root \tilde{W}ₙ¹, from which other twiddle factors \tilde{W}ₙ¹ for the NTT on R_{Q} [x] may be computed by exponentiating \tilde{W}ₙ¹ the appropriate number i of times.

In some implementations, the twiddle factors for the NTT on R_{Q} [x] may be based on the principal root of unity γ that is obtained as follows. First, Bezout coefficients a=q⁻¹ mod m and b=m⁻¹ mod q are defined, so that aq+mb=1, where m=Q/q. This may be accomplished, e.g., using the Euclidean algorithm (or the extended Euclidean algorithm). An additional root of unity β modulo m may be precomputed, βⁿ mod m=1. A principal root of unity modulo Q=mq may then be computed as γ=aqβ+bmWₙ¹ since

$${γ}^{n} ≡ {( aq β + {bmW}_{n}^{1} )}^{n} ( mod mq ) ≡ {a}^{n} {q}^{n} {β}^{n} + {b}^{n} {m}^{n} {W}_{n}^{n} ( mod mq ) ≡ {a}^{n} {q}^{n} + {b}^{n} {m}^{n} ( mod mq ) ≡ {( aq + bm )}^{n} mod mq ≡ 1 mod Q .$$

The obtained root γ may be used, γ→\tilde{W}ₙ¹, as the principal root for the NTT on R_{Q} [x], which results in correct polynomial multiplication products modulo q. The new principal root of unity, γ, may additionally be masked with masks that are integer multiples of q, e.g., as disclosed above.

In some implementations, masks for the principal roots/twiddle factors may be randomly selected subject to suitable fitness criteria. For example, the fitness criteria may include verifying that the principal roots/twiddle factors are non-zero (modulo m=Q/q). In another example, the fitness criteria may include verifying that the NTT in the auxiliary domain is invertible (e.g., represented by a matrix having a non-zero determinant) in Z_{Q}.

FIG. 4 depicts a flow diagram of an example method 400 of protecting secret data against side-channel attacks by domain embedding of polynomial computations, in accordance with one or more aspects of the present disclosure. Method 400 disclosed below, and/or each of its individual functions, routines, subroutines, or operations may be performed by one or more processing units of a suitable computing system, e.g., by processor 220 and/or cryptographic engine 250 of computing device 202. In some implementations, method 400 may be performed by an arithmetic logic unit, an FPGA, an ASIC, a cryptographic accelerator, a dedicated hardware circuit, and the like, or any suitable processing logic, hardware or software or a combination thereof. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. Various operations of method 400 may be performed in a different order compared with the order shown in FIG. 4. Some blocks of method 400 may be performed concurrently with other blocks. Some blocks of method 400 may be optional.

Method 400 may include, at block 410, identifying, using a processing device, a plurality of input polynomials, such as a first polynomial (e.g., s(x)) associated with a first data and a second polynomial (e.g., c(x)) associated with a second data. In some implementations, the first data may be a secret data (e.g., a private key or any secret information obtained using the private key) and the second data may be a non-secret or public data (e.g., a ciphertext in decryption algorithms, a document hash in digital signature algorithms, and/or the like). The plurality of polynomials may be defined on a working domain, e.g., with coefficients defined modulo a first modulus (e.g., q) and with polynomial operations defined modulo any suitable irreducible polynomial (e.g., a degree n polynomial). The combination of the first modulus and the degree of the irreducible polynomial represents a dimension of the working domain, e.g., a different number of ways in which coefficients of a given polynomial may be selected (e.g., q×n, where each of n coefficients of a degree n−1 polynomial may be selected from q different values).

At block 420, method 400 may continue with the processing device mapping the plurality of input polynomials to an auxiliary domain. The auxiliary domain may have a second dimension (e.g., Q×n) that is different from the first dimension. In some implementations, the second dimension is greater than the first dimension. In some implementations, the second modulus Q may be randomly sampled from a target range of values. In some implementations, the target range of values may be determined by at least one of: (1) a bit size of one or more registers storing coefficients of the plurality of masked polynomials, or (2) an operand size of a processing unit that supports computation of the one or more NTTs. For example, the second modulus Q may be selected using a restricted random sampling from such values that (1) are divisible by q, and (2) do not exceed 2^{N}−1, where N is the bit size of registers/processing unit operands. In some implementations, mapping of the polynomials may maintain coefficients of the respective polynomials while defining the polynomials in the new-auxiliary-domain. In some implementations, mapping of the polynomials to the auxiliary domain may also include modification of the coefficients (e.g., using any reversible transformation).

Operations of block 420 may further include generating a plurality of masking polynomials, e.g., a first masking polynomial and a second masking polynomial. In some implementations, the first masking polynomial and the second masking polynomial are associated with a kernel of a homomorphism transformation from the auxiliary domain to the working domain. For example, coefficients of the masking polynomials (e.g., polynomials qM_{S}(x) and qM_{C}(x)) may be divisible by the first modulus q and may be defined modulo the second modulus Q.

At block 430, method 400 may include masking the first mapped polynomial with a first masking polynomial to obtain a first masked polynomial and, similarly, masking the second mapped polynomial with a second masking polynomial to obtain a second masked polynomial. In some implementations, as indicated with the callout block 432 in FIG. 4, masking the first (second) mapped polynomial with the first (second) masking polynomial is performed by adding a product of the first modulus and each of a plurality of randomly-sampled coefficients of the first (second) masking polynomial to a respective same-degree coefficient of the first (second) mapped polynomial (e.g., S_{M}(x)=s(x)+qM_{S}(x); C_{M}(x)=c(x)+qM_{C}x)).

At block 440, method 400 may include performing, using the first masked polynomial and the second masked polynomial, one or more computations in the auxiliary domain, e.g., one or more Number Theoretic Transforms (NTTs) performed modulo the second modulus. More specifically, as indicated with callout block 442, the one or more computations may include computing a first NTT of the first masked polynomial and computing a second NTT of the second masked polynomial. At callout block 444, the one or more computations may continue with an elementwise multiplication product of the first NTT and the second NTT. At block 446, the one or more computations may include an inverse NTT of the elementwise multiplication product of the first NTT and the second NTT.

In some implementations, the first NTT and the second NTT may be computed using a plurality of butterfly operations that deploy a plurality of twiddle factors, where one or more twiddle factors are masked using random numbers divisible by the first modulus. In some implementations, the first NTT of the first masked polynomial, the second NTT of the second masked polynomial, and/or the inverse NTT of the elementwise multiplication product may be based on a root of unity modulo the second modulus, wherein the root of unity modulo the second modulus (e.g., γ, as described above) is computed using a root of unity modulo the first modulus (e.g., Wₙ¹).

At block 450, method 400 may include obtaining an output of the cryptographic operation (e.g., a plaintext in decryption algorithms, a document hash in digital signature algorithms, and/or the like) by transforming an output of the one or more computations (e.g., the output of the inverse NTT) from the auxiliary domain to the working domain. For example, the polynomial multiplication product output by the inverse NTT may be reduced modulo the first modulus.

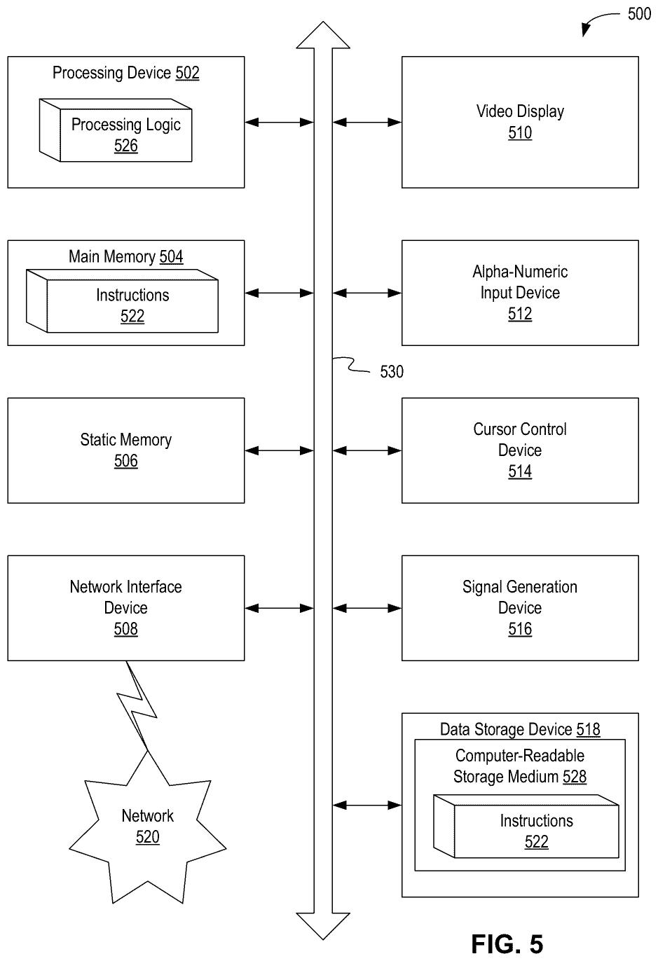

FIG. 5 depicts a block diagram of an example computer system 500 operating in accordance with one or more aspects of the present disclosure. In various illustrative examples, computer system 500 may represent computing device 202, illustrated in FIG. 2. Example computer system 500 may be connected to other computer systems in a LAN, an intranet, an extranet, and/or the Internet. Computer system 500 may operate in the capacity of a server in a client-server network environment. Computer system 500 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 500 may include a processing device 502 (also referred to as a processor or CPU), which may include processing logic 526, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 502 may be configured to execute instructions implementing example method 400 of protecting secret data against side-channel attacks by domain embedding of polynomial computations.

Example computer system 500 may further comprise a network interface device 508, which may be communicatively coupled to a network 520. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 may include a computer-readable storage medium (or, more specifically, a non-transitory computer-readable storage medium) 528 on which is stored one or more sets of executable instructions 522. In accordance with one or more aspects of the present disclosure, executable instructions 522 may comprise executable instructions implementing example method 400 of protecting secret data against side-channel attacks by domain embedding of polynomial computations.

Executable instructions 522 may also reside, completely or at least partially, within main memory 504 and/or within processing device 502 during execution thereof by example computer system 500, main memory 504 and processing device 502 also constituting computer-readable storage media. Executable instructions 522 may further be transmitted or received over a network via network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method to perform a cryptographic operation, the method comprising:
mapping, to an auxiliary domain, each of (i) a first polynomial associated with a first data and defined on a working domain and (2) a second polynomial associated with a second data and defined on the working domain, wherein the working domain has a first dimension and the auxiliary domain has a second dimension that is greater than the first dimension;
masking, using a processing device, the first mapped polynomial with a first masking polynomial to obtain a first masked polynomial;
masking, using the processing device, the second mapped polynomial with a second masking polynomial to obtain a second masked polynomial, wherein the first masking polynomial and the second masking polynomial are associated with a kernel of a homomorphism transformation from the auxiliary domain to the working domain;
performing, using the first masked polynomial and the second masked polynomial, one or more computations in the auxiliary domain; and
obtaining, using the processing device, an output of the cryptographic operation, wherein obtaining the output comprises transforming an output of the one or more operations from the auxiliary domain to the working domain.

2. The method of claim 1, wherein coefficients of each of the first polynomial and the second polynomial are defined modulo a first modulus in the working domain, wherein coefficients of each of the first masked polynomial and the second masked polynomial are defined modulo a second modulus in the working domain, and wherein the first modulus divides the second modulus.

3. The method of claim 2, wherein masking the first mapped polynomial with the first masking polynomial comprises adding a product of the first modulus and each of a plurality of randomly-sampled coefficients of the first masking polynomial to a respective same-degree coefficient of the first mapped polynomial.

4. The method of claim 2, wherein the second modulus is randomly sampled from a target range of values.

5. The method of claim 4, wherein the target range of values is determined by at least one of:
a bit size of one or more registers storing coefficients of the first masked polynomial; or
an operand size of a processing unit that performs the one or more computations in the auxiliary domain.

6. The method of claim 1, wherein the one or more computations in the auxiliary domain comprise a first Number Theoretic Transform (NTT) of the first masked polynomial, and a second NTT of the second masked polynomial.

7. The method of claim 6, wherein the one or more computations in the auxiliary domain further comprise:
an elementwise multiplication of the first NTT and the second NTT, and
an inverse NTT of an output of the elementwise multiplication of the first NTT and the second NTT.

8. The method of claim 6, wherein the first NTT and the second NTT are computed using a plurality of butterfly operations that deploy a plurality of twiddle factors, wherein one or more twiddle factors of the plurality of twiddle factors are masked using random numbers divisible by the first modulus.

9. The method of claim 6, wherein the first NTT of the first masked polynomial is based on a root of unity modulo the second modulus, and wherein the root of unity modulo the second modulus is computed using a root of unity modulo the first modulus.

10. A method to perform a cryptographic operation, the method comprising:
identifying, using a processing device, a plurality of input polynomials with coefficients defined modulo a first modulus;
generating, using the processing device a plurality of masking polynomials with coefficients divisible by the first modulus and defined modulo a second modulus that is greater than the first modulus;
obtaining a plurality of masked polynomials, wherein each of the plurality of masked polynomials is computed, modulo the second modulus, using a respective input polynomial of the plurality of input polynomials and a respective masking polynomial of the plurality of masking polynomials;
computing, using one or more Number Theoretic Transforms (NTTs) performed modulo the second modulus, a polynomial multiplication product of the plurality of masking polynomials; and
obtaining, using the processing device, an output of the cryptographic operation using the polynomial multiplication product reduced modulo the first modulus.

11. The method of claim 10, wherein the first modulus divides the second modulus.

12. The method of claim 10, wherein coefficients of each of the plurality of masking polynomials are randomly-sampled from a set of numbers divisible by the first modulus.

13. The method of claim 10, wherein the second modulus is randomly sampled from a target range of values.

14. The method of claim 13, wherein the target range of values is determined by at least one of:
a bit size of one or more registers storing coefficients of the plurality of masked polynomials; or
an operand size of a processing unit that supports computation of the one or more NTTs.

15. The method of claim 10, wherein computing the polynomial multiplication product comprises computing, modulo the second modulus:
a first NTT of a first masked polynomial of the plurality of masked polynomials;
a second NTT of a second masked polynomial of the plurality of masked polynomials;
an elementwise multiplication product of the first NTT and the second NTT, and
an inverse NTT of the elementwise multiplication product of the first NTT and the second NTT.

16. The method of claim 11, wherein the one or more NTTs are computed using a plurality of butterfly operations that deploy a plurality of twiddle factors, wherein at least a subset of the plurality of twiddle factors are masked using random numbers divisible by the first modulus.

17. A processing device comprising:
one or more registers to store a first polynomial associated with a first data and a second polynomial associated with a second data, wherein the first polynomial and the second polynomial and defined on a working domain having a first dimension; and
one or more processing units to:
map, to an auxiliary domain, the first polynomial and the second polynomial to an auxiliary domain having a second dimension that is greater than the first dimension;
mask the first mapped polynomial with a first masking polynomial to obtain a first masked polynomial;
mask the second mapped polynomial with a second masking polynomial to obtain a second masked polynomial, wherein the first masking polynomial and the second masking polynomial are associated with a kernel of a homomorphism transformation from the auxiliary domain to the working domain;
perform, using the first masked polynomial and the second masked polynomial, one or more computations in the auxiliary domain; and
obtain an output of the cryptographic operation, wherein obtaining the output comprises transforming an output of the one or more operations from the auxiliary domain to the working domain.

18. The processing device of claim 17, wherein coefficients of each of the first polynomial and the second polynomial are defined modulo a first modulus in the working domain, wherein coefficients of each of the first masked polynomial and the second masked polynomial are defined modulo a second modulus in the working domain, and wherein the first modulus divides the second modulus.

19. The processing device of claim 18, wherein to mask the first mapped polynomial with the first masking polynomial, the one or more processing units are to add a product of the first modulus and each of a plurality of randomly-sampled coefficients of the first masking polynomial to a respective same-degree coefficient of the first mapped polynomial.

20. The processing device of claim 17, wherein the one or more computations in the auxiliary domain further comprise:
an elementwise multiplication of the first NTT and the second NTT, and
an inverse NTT of an output of the elementwise multiplication of the first NTT and the second NTT;
wherein the first NTT and the second NTT are computed using a plurality of butterfly operations that deploy a plurality of twiddle factors, wherein one or more twiddle factors of the plurality of twiddle factors are masked using random numbers divisible by the first modulus.
